(19) United States
(12) Patent Application Publication
(10) Pub. No.: US 2015/0213295 A1
(43) Pub. Date: Jul. 30, 2015

(54) LOW ENERGY LOCATION MANAGEMENT SYSTEMS AND METHODS

(71) Applicants: David Ginsburg, Los Gatos, CA (US); Alan Simon, Toronto (CA)

(72) Inventors: David Ginsburg, Los Gatos, CA (US); Alan Simon, Toronto (CA)

(21) Appl. No.: 14/605,609

(22) Filed: Jan. 26, 2015

Related U.S. Application Data
(60) Provisional application No. 61/932,474, filed on Jan. 28, 2014.

(51) Int. Cl. G06K 7/10

(52) U.S. Cl. CPC G06K 7/10297; G06K 7/10366

(57) ABSTRACT

Methods and systems for monitoring the location of animate and inanimate objects include tags operatively connected to the object configured for wireless communication with one or more hubs within a monitoring site. The tags may send preemptive identifying signals to the hubs when in a range of communication using Bluetooth Low Energy signals. The hubs may register with the tags within a certain location and send status signals over a network. The status signals may be used to monitor the location of the objects and tags, and may be used to generate messages indicating location information of the objects. Cloud based computing may be used to run applications and databases to monitor and share tag location information.

### CROSS-REFERENCE TO RELATED APPLICATIONS

This application claims the benefit of U.S. Provisional Application No. 61/932,474 filed Jan. 28, 2014, which is incorporated herein in its entirety.

### BACKGROUND OF THE DISCLOSURE

The present disclosure relates to systems and methods of monitoring the location or status of animate and inanimate objects.

Location and status monitoring of animate or inanimate objects has been increasingly adopted and implemented in a variety of applications. For example, schools and daycares may desire to monitor the location or status of students, individuals or pet boarding locations may desire to monitor the location of pets, and a variety of businesses may desire to monitor the location of employees and assets. Existing methods and systems including the use of Radio-Frequency Identification (RFID) and fixed-location Bluetooth beacons require custom configurations for the particular application and on-site data management and do not allow for external device connectivity.

### SUMMARY OF THE DISCLOSURE

The disclosure relates to low energy systems for managing and monitoring the location or status of moving animate or inanimate objects. In some embodiments, one or more tags may be attachable to people or assets. The tags may communicate to one or more hubs within a range of communication. The communication may include the tag broadcasting an identifying signal through Bluetooth wireless signals to a receiver incorporated within the hub. The hubs may communicate with a network to allow on-site and external computing devices to receive status information relating to the tag and hub. On-site or external applications may use status data to generate and store messages indicating the change in status of tags in relation to hubs at the monitoring site. Such systems and methods may be implemented in a variety of public and private applications, such as monitoring of students, employees, pets, and inanimate assets.

One aspect of the disclosed embodiments is a method for monitoring the location of one or more tags. The method includes receiving, at a first computing device, a preemptive signal from a tag having identification information of the tag, wherein the tag is operatively connected to an object. In response to receiving the signal, the first computing device determines if the first computing device has received the signal from the tag for a predetermined period of time. A tag status signal may be generated having a location of the tag within a monitoring site, and the tag status signal may be transmitted over a network to a second computing device.

Another aspect of the disclosed embodiments is a method comprising receiving, at a first computing device, a preemptive Bluetooth signal from a tag, the signal containing identification information about the tag and a first registered device. In response to receiving the signal, the first computing device determines if the first computing device has received the signal from the tag for a predetermined period of time, de-registers the tag with the first registered device, generates a tag status signal having a location of the tag within a monitoring site, and transmits the tag status signal over a network to a second computing device.

Yet another aspect of the disclosed embodiments is a system for monitoring the location of one or more tags is disclosed. The system may include a tag configured to transmit, at regular intervals, a Bluetooth wireless signal having information identifying the tag. It may also include a plurality of hubs configured to receive the Bluetooth wireless signal when the tag is within a range of communication with the hub. The hubs may include a memory and a processor configured to execute instructions stored in the memory to determine if the hub has received the Bluetooth wireless signal from the tag for a predetermined period of time, and generate and transmit a tag status signal having location information of the tag. The system may further include a first computing device communicatively linked with the hub having a processor programmed to initiate executable operations. The operations may include receiving the tag status signal, determining if the tag is within an acceptable location within a monitoring site, generating a message based on the determination, and transmitting the message over a network to a second computing device.

Variations in these and other aspects, features, elements, implementations, and embodiments of the methods, systems, and apparatuses are disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a portion of a location monitoring system in which the aspects, features, and elements disclosed herein may be implemented;

FIG. 2 is a diagram of an example monitoring site having a plurality of tags and hubs;

FIG. 3 is a diagram of an example of a portion of a location monitoring system having an external application and database;

FIG. 4 is a block diagram showing an example of a hardware configuration for a tag;

FIG. 5 is a block diagram showing an example of a hardware configuration for a hub;

FIG. 6 is a flowchart showing an example of a process of communication between a tag, hub, and network;

FIG. 7 is a flowchart showing an example of a process of communication when a tag is registered with a hub and when a tag is out of range from a hub; and

FIG. 8 is a flowchart showing an example of a process of communication and message generation based on the status of one or more tags.

### DETAILED DESCRIPTION

The disclosure relates to low energy systems and methods for managing and monitoring the location or status of moving persons, animals, or assets within a monitoring site. Systems and methods herein may utilize devices that communicate using low-energy wireless communications protocols. For example, the low-energy wireless communication protocol may be achieved using low energy Bluetooth devices. In some embodiments, one or more beacon tags may be attachable to objects. Each tag may communicate to one or more hubs via an identifying Bluetooth broadcast sent from the tag to any hubs within a range of communication. The hubs may communicate over a network status information relating to the tags, such as when a tag registers with a hub, when a tag is out of range with a previously registered hub, or status from a tag sensor. External computing devices may be leveraged to access, manipulate, store, and share real-time and past information relating to the status of the tags. Such systems and methods may be easily implemented in a variety of different public and private applications, such as the monitoring of students, employees, pets, and inanimate objects.

As used herein, the terminology “objects” or “assets” may include any animate or inanimate object. For example, objects may include persons, animals, and inanimate assets.

As used herein, the terminology “processor” includes a single processor or multiple processors, such as one or more general purpose processors, one or more special purpose processors, one or more conventional processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any non-transitory computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “instructions” may include directions for performing any method, or any portion or portions thereof, disclosed herein, and may be realized in hardware, software, or any combination thereof. For example, instructions may be implemented as information stored in the memory, such as a computer program, that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. Portions of the instructions may be distributed across multiple processors on the same machine or different machines or across a network such as a local area network, a wide area network, the Internet, or a combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

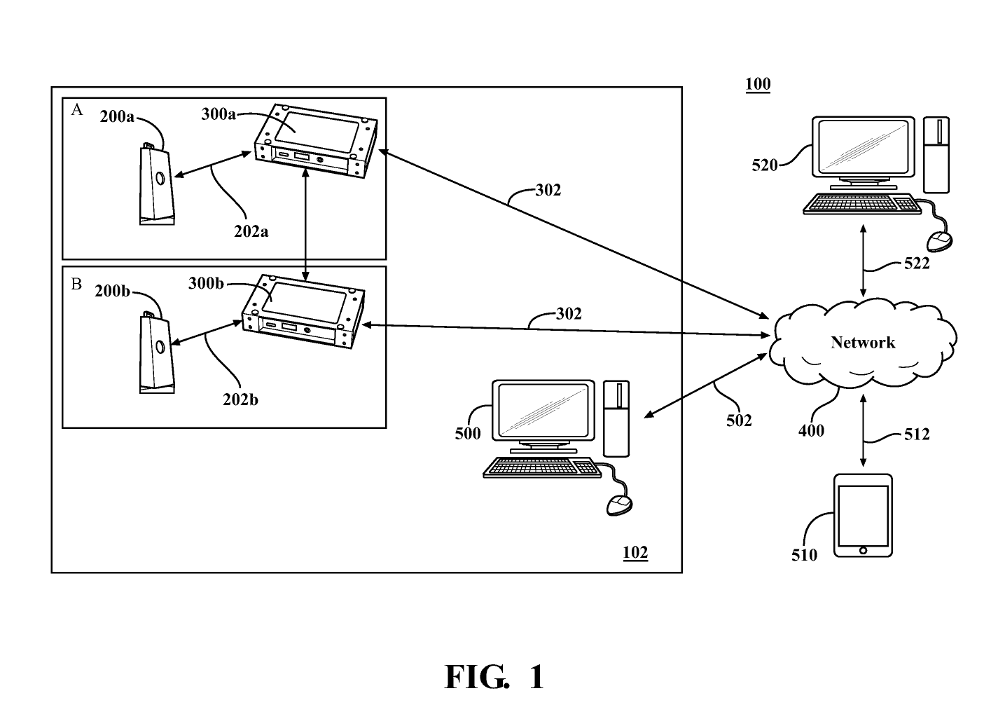

FIG. 1 is a diagram of an example of a portion of a location monitoring system 100 in which the aspects, features, and elements disclosed herein may be implemented. The monitoring system 100 may include a monitoring site 102 and may include one or more mobile tags 200, one or more hubs 300, one or more networks 400, one or more on-site computing devices 500, and one or more external computing devices 510/520, or any combination thereof. While FIG. 1 shows two tags 200a/200b, two hubs 300a/300b, and a network 400, any number of tags, hubs, and networks may be used. In some embodiments, the location monitoring system 100 may include devices, units, or elements not shown in FIG. 1.

Monitoring site 102 may represent a variety of different application deployment sites. For example, monitoring site 102 may represent a portion of a school, day care, pet care facility, or business location. In some embodiments, monitoring site 102 may include multiple distinct areas, such as different rooms or elevation levels. For example, monitoring site 102 may include at least a first room A and a second room B. Monitoring site 102 includes one or more hubs 300 associated with particular locations of monitoring site 102. For example, a first hub 300a may be located within first room A and a second hub 300b may be associated with second room B. Monitoring site 102 may include one or more on-site computing devices 500 capable of communicating with tags 200, hubs 300, or network 400.

Tags 200 may be operatively connectable to a person or object belonging in a group of animate or inanimate objects in which location management and monitoring is desired. The term “operatively connected” can include direct or indirect connections, including connections without direct physical contact. Tags 200 may be removably attachable to a person, pet, or object via any attachment methods. For example, tag 200 may be attached using straps, adhesives, key rings, and VELCRO. Additionally, tag 200 may be attachable or otherwise incorporated into wearable articles such as belts, shoes, and jewelry. Tag 200 may be sized appropriately for the application, and may be water resistant or waterproof, and may allow for components such as batteries to be replaced or changed. Tags 200 may be provided with monitoring system 100 or in some examples, third party tags or beacons may also register with monitoring system 100 in public use cases.

Tags 200 may be configured to communicate with hubs 300 or computing devices 500/510/520. In some embodiments described herein, tags 200 communicate wirelessly with hubs 300 via Bluetooth radio signal communication links 202. For example, tag 200 may operate as a Bluetooth beacon capable of transmitting information to hub 300. In such embodiments, the terms “charm” and “beacon” and “bTag” may be used interchangeably to describe tag 200. Tag 200 may be configured to transmit information to hub 300 using Bluetooth low energy (Bluetooth LE, BLE, or Bluetooth Smart) to reduce power consumption at tag 200. More specifically, Bluetooth LE 4.0 protocol may be used for communication between tag 200 and hub 300. Each tag 200 may be uniquely identifiable, such as by a 48-bit Bluetooth media access control address (MAC address). In some examples, tag 200 may be a TEXAS INSTRUMENTS Bluetooth Smart CC2541 Sensortag. While embodiments described herein and in the Figures utilize Bluetooth communication signals, it is contemplated other technologies and communication links may be used to allow communication between tag 200 and hub 300. For example, tag 200 may communicate with hub 300 via a variety of wireless signals, such as near field communication (NFC), frequency modulated radio signals, and wireless networks such as WiFi.

In some embodiments, tags 200 may include a variety of sensors operatively associated therewith. Such sensors may be integral with tag 200 or may be external and communicatively linked to tag 200. Tag 200 may have sensors to detect information relating to the person, object, or environment. In some embodiments, tag 200 may include magnetic closures to allow determination of entry or exit in certain locations. Tag 200 may include one or more sensors activated by a person, such as switches or buttons. For example, tag 200 may include a panic button that sends a signal to hub 300 that immediate assistance is needed. Furthermore, tag 200 may include temperature sensors, motion sensors, accelerometers, and vibration sensors. Data from tag sensors may be sent to hubs 300 with identification signals, or alternatively, may be sent to hubs 300 or network 400 via alternative wireless communication methods.

Hubs 300 may be any device configured to communicate with tags 200 and network 400. For example, hubs 300 may receive Bluetooth broadcast signals from tags 200 over communication links 202. Additionally, hubs 300 may communicate with network 400 via communication links 302. Hubs 300 may access and communicate with network 400 using any wired or wireless communication medium. For example, hubs 300 may be connect to the Internet or a cellular data network via routers at monitoring site 102. Hubs 300 may communicate directly with each other. For example, hub 300a may communicate to hub 300b via a wired or wireless network at monitoring site 102. In some examples, hubs 300 may be computing devices such as RASPBERRY PI single board computing device.

In some examples, hubs 300 may remain fixed within monitoring site 102 to create a static area to be monitored. In other examples, hubs 300 may be moveable within monitoring site 102. Hubs 300 are shown distinct from other computing devices in the Figures, but it is contemplated that on-site computing device 500 and external computing devices 510/520 may be a hub 300. For example, a mobile device 510 may act as a hub 300 to receive communication from one or more tags 200 and include applications or programs having similar instructions.

Tags 200 may include instructions for communicating with hubs 300. In some embodiments, tags 200 are configured to broadcast identification information via Bluetooth LE 4.0 signals. As used herein, the term “identification information” may include any data or information capable of identifying the source of a transmission from a tag 200. Is some examples, identification information may be forms of network addresses assigned by manufacturers of the tag 200 and may include a 48-bit MAC address. In some embodiments, identification information may be programmable to include custom identifiers. For example, tag 200 may be programmed to include characteristics of an object, such as name, type of object, etc. Identification information may include numbers, letters, images, symbols or other characters or portion or combination thereof.

Tag 200 may follow traditional Bluetooth procedures, such as initiating communication by sending advertisement signals on regular intervals advertising their presence in an area. In conventional Bluetooth devices, the initial advertisement messages do not include identification information, but rather represent requests for additional communication from nearby devices. Hub 300 may receive such messages and respond with requests for additional identifying information from the tag 200. Tag 200 may respond with identifying information and the two devices may be traditionally “paired.”

Some embodiments, however, may have adapted communication processes to reduce complexity and increase battery life. In some examples, tag 200 instructions may be modified to cause tag 200 to send identification information in an original and preemptive signal. As used herein, the term “preemptive signal” may include any signal configured to be sent without being prompted or requested by another device. In some examples, tag 200 is configured to send preemptive signals having identification information without hub 300 or another device requesting such information. Tag 200 may also be modified to ignore any requests sent by hub 300 for further information, such as requests for identifying information. In some embodiments, hub 300 may be instructed to passively scan for devices such as tags 200, and not to actively send requests for more information.

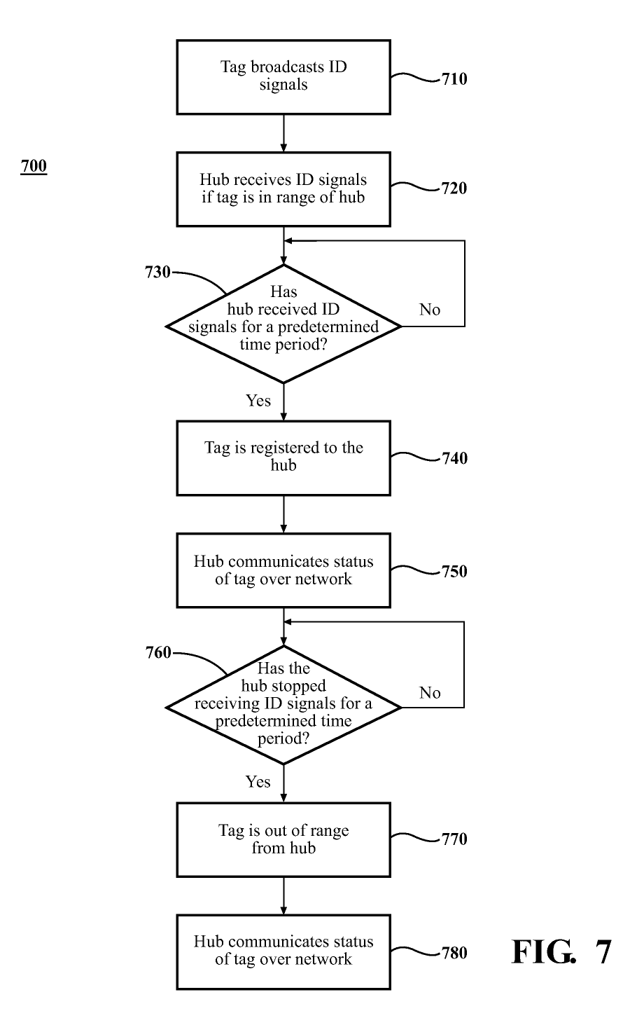

In some embodiments, hub 300 may be required to monitor several tags 200. For example, in school settings upwards of 50 tags may be within a range of communication with one hub 300. Instructions or programs installed with hub 300 may allow hub 300 to listen or monitor for identification signals from tags 200 rather than keeping concurrent connections with tags 200. As further described with reference to FIG. 7, hub 300 may determine tag 200 to be registered to the hub 300 after receiving identifying information signals from the tag 200. As used herein, the term “register” in reference to tag 200 and hub 300 may include any determination that tag 200 should be associated with a hub 300 for purposes of monitoring a location of tag 200. For example, data relating to which hubs tag 200 has registered with may allow for the tracking of the location of tag 200 within monitoring site 102. In some embodiments, a tag 200 is determined to be registered with a hub 300 after communication between tag 200 and hub 300 over a predetermined time period. As one example, hub 300 may determine a tag 200 to be registered after receiving identification information for approximately 20 seconds. As another example, a hub 300 may determine tag 200 is registered after receiving any signal including identification information, regardless of a time period or number of times transmitted. Similarly, hub 300 may determine tag 200 to be out of range or timed out after a time period of not receiving such signals from tag 200. As used herein, the terms “out of range,” “de-registered,” or “timed out” with reference to tag 200 and hub 300 may mean any determination that tag 200 is no longer within a range of communication with hub 300, no longer communicating identifying information, or no longer should be monitored by hub 300. This programming of tag 200 and hub 300 allows the system to reduce the need to initiate full discovery processes between tag 200 and hub 300 when not required and allows the efficient monitoring of multiple tags 200.

In some embodiments, Tag 200 may be configured to send identifying signals at different intervals to conserve power and reduce environmental radio interference. As one example, tag 200 may be instructed to send signals every two seconds. As another example, tag 200 may be instructed to send the identifying signals every thirty seconds. The time interval between successive instances of transmission of the identifying signals can be a predetermined transmission time interval. In such an implementation, the predetermined transmission time interval can be known by the hub 300 and utilized by the hub 300 as a basis for determining whether the tag 200 should be registered to the hub. For instance, the hub 300 could determine that the tag 200 should be registered if all expected transmissions of the identifying signal are received at the hub over a period of time that is greater than the predetermined transmission time interval. Thus, in one example, if the predetermined transmission time interval is two seconds, the hub 300 can determine that the tag 200 should be registered if the identifying signals are received consistently every two seconds over a predetermined time period such as twenty seconds. On the contrary, if the identifying signals are received only sporadically, such by reception at the hub of transmissions every two seconds for less than the predetermined time period prior to an interruption that is greater than the predetermined transmission time interval, the tag 200 is not registered at the hub.

In some embodiments, Hub 300 may communicate information relating to tag 200 to other computing devices in monitoring system 100. In some embodiments, hub 300 sends one or more signals containing tag status information through network 400. As used herein, the term “tag status” may include any information or data relating to the registered status, the location, environment, or attached object of the tag 200. In some examples, hub 300 may communicate whether tag 200 is registered with the hub 300. Hub 300 may determine a tag 200 is registered, and send tag status signals indicating the registering real-time to other computing devices. In other examples, hub 300 may record register data locally and at certain times send such information over network 400. In some embodiments, hub 300 may determine the location of tag 200, such as a particular room or area within monitoring site 102 and that may be included in a tag status signal.

In some embodiments, hub 300 receives data from one or more tag sensors and sends related information over a network. Hub 300 may simply send the data received from sensor readings, or may process such data to determine when to include tag sensor information with a tag status. For example, hub 300 may be configured to include warnings or updates with a tag status when a temperature reading from a temperature tag sensor is above or below a certain threshold. Tag status from tag sensors may be combined with tag-hub registration information, or may be stored or sent separately over a network.

The various components of monitoring system 100 can be communicatively linked through one or more networks. As used herein, the term “communicatively linked” can include direct or indirect connections through a communication channel or pathway or another component or system. A “network” means one or more components designed to transmit and/or receive information from one source to another. For example, two or more components in monitoring system 100 may be communicatively linked to each other using network 400. Network 400 may be any type of network configured to provide for data, voice, or any other type of electronic communication. For example, the network 400 may be a local area network (LAN), wide area network (WAN), virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, network 400 may include any number of interconnected elements. In some embodiments, network 400 is the Internet, and hubs 300, on-site computing device 500, and external computing devices 510/520 may access network 400 using wired or wireless routers or cellular data network signals as communication links.

While network 400 is shown substantially externally to monitoring site 102 in FIG. 1, it is contemplated that network 400 may exist both internal and external to monitoring site 102. Network 400 may also be comprised of multiple networks both internal and external to monitoring site 102. For example, an external network may include the Internet or cellular telephone network, while an internal network may include a LAN, WAN, or VPN. Hubs 300 may connect directly to network 400 in some embodiments, or communicate with network 400 via on-site computing device 500.

On-site computing device 500 may be any computing device in communication with network 400 and located at or near monitoring site 102. For example, computing device 500 may include a traditional desktop computer, a server, a laptop computer, a notebook computer, a mobile telephone, a tablet, a PDA, and the like. On-site computing device 500 may fully or partially run software applications to access, record, store, or share data relating to tags 200 and hubs 300. On-site computing device 500 may communicate with network 400 via communication link 502, which may include any wired or wireless data communication methods.

External computing devices 510/520 may be any computing devices in communication with network 400. For example, computing device 510 may be a mobile computing device in communication with network 400 and may include any type of mobile computing device, including handheld devices. The mobile computing device 510 can be, for example, a smartphone (e.g., computationally-enabled mobile telephone), a laptop computer, a notebook computer, a mobile telephone, a tablet, a PDA, and the like. Mobile computing device 510 may communicate with network 400 via communication link 512 that may include any wireless communication such as WiFi and cellular networks.

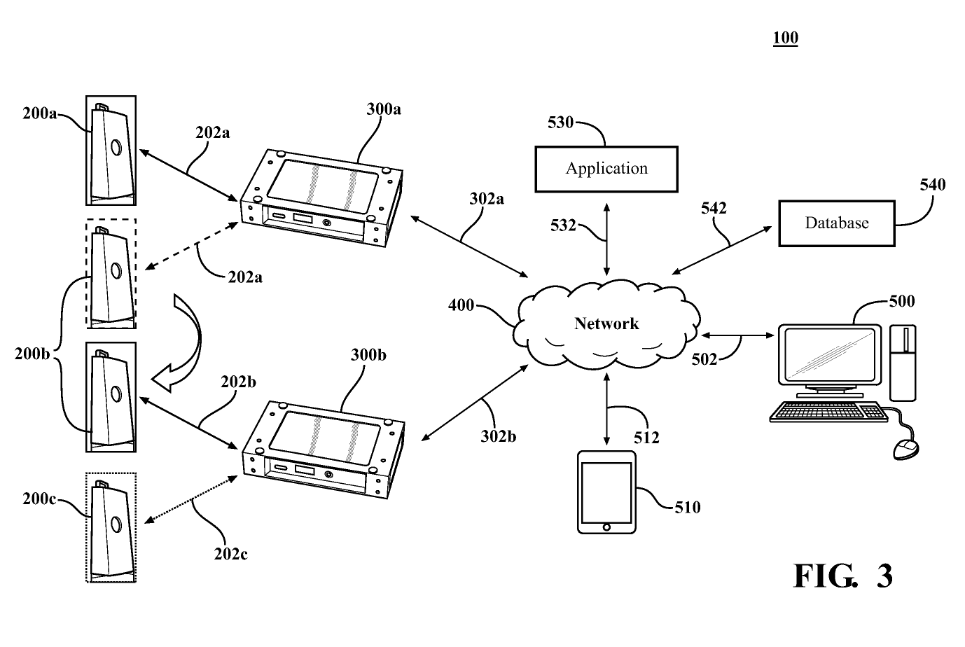

External computing device 520 may include devices provided by a computing “cloud.” For example, the cloud can comprise a collection of computing devices that may be located centrally or distributed that provide services to network 400. As shown in FIG. 3 and discussed below, cloud-based computing device 520 may at least partially include an application 530 and a database 540. Cloud computing device 520 may include application 530 that is accessible via a web interface over the Internet. Cloud computing device 520 may communicate with network 400 via communication link 522, which may include any wired or wireless data communication methods.

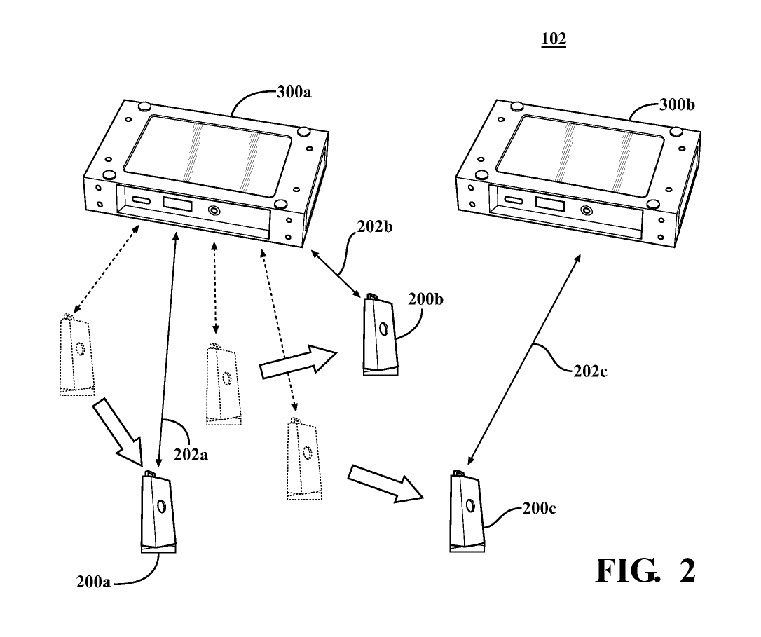

FIG. 2 is a diagram of an example monitoring site 102 having a plurality of mobile tags 200 and a plurality of fixed hubs 300. For example, three tags are shown, first tag 200a, second tag 200b, and third tag 200c and two hubs are shown, first hub 300a and second hub 300b. Tags 200a-c may communicate with one or more hubs when the tag 200 is within a range of communication. For example, first tag 200a and second tag 200b are in communication with hub 300a as each of the tags 200a-b move within the range of communication. Third tag 200c is shown starting in range of hub 300a, but moves to a location outside the range of communication with hub 300a but within the range of communication with hub 300b. A range of communication between tag 200 and hub 300 is dependent on communication signal strengths and hardware of tag 200 and hub 300. A plurality of hubs 300 may be chosen and located throughout a monitoring site 102 to achieve desired coverage where tags 200 would be inside a range of communication with at least one hub 300.

FIG. 3 is a diagram of an example of a portion of a location monitoring system 100 having an application 530 and database 540. In some embodiments, application 530 and database 540 may be maintained on premise at the monitoring site 102. For example, at least a portion of application 530 and database 540 may be stored, accessed, or maintained at on-site computing device 500. Alternatively, application 530 and database 540 may be maintained externally, such as on a cloud-based external computing device 520. In some examples, application 530 may have separate portions associated with a cloud computing device 520, hubs 300, on-site computing device 500, or mobile computing device 510. Application 530 and database 540 may be configured to communicate with network 400, such as through communication links 532/542. Additionally, application 530 and database 540 may communicate directly with one another. Computing device 500, mobile computing device 510, application 530, and database 540 are shown as separate elements in FIG. 3, but it is contemplated that one or more may be integrated together.

In some embodiments, application 530 may be a software program configured to manage the hubs 300 and store, manipulate, or share data received from tags 200 or hubs 300. In some embodiments, database 540 may be customized based on application and may contain data associated with each tag 200. In some embodiments, application 530 and database 540 may have visibility in all tags associated with a monitoring site 102. Application 530 and database 540 may contain information about monitoring site 102, such as hubs 300 numbers and location.

Application 530 and database 540 may manage monitoring system 100 in a variety of ways. In some embodiments, application 530 may allow for information about a person or object to be stored in database 540 that correlates the person or object with a tag identification signal. For example, the name and emergency contact information for a student may be saved in database 540 along with the corresponding MAC identification of a tag 200.

In some embodiments, database 540 may receive and store tag status information from hubs 300. For example, hubs 300 may send status signals through network 400 whenever a tag 200 is registered or goes out of range with the hub 300. Thus, location of tag 200 may be determined based on which hubs 300 tag 200 is registered with. Application 530 may also provide the basis for monitoring the location of tags 200 through one or more user interfaces. For example, application 530 may be at least partially executed on a cloud based computer, while having web based interaction with other computing devices. That is, on-site computing device 500 and mobile computing device 510 may communicate with application 530 via network 400 to access, read, or execute portions of application 530 or database 540. In some examples, an administrator or family member may access application 530 to determine the present location or location history of a person or object associated with a tag 200. Application 530 may use a variety of user interfaces, such as maps displaying the location of monitoring site 102, hub 300, and tag 200. In one example, application 530 may be configured to automatically register students when entering and leaving the building, while tracking them throughout the course of the day.

In some embodiments, application 530 may be configured to determine if tag 200 is within an acceptable location within monitoring site 102. Acceptable locations may be defined in several ways depending on the application. In some examples, acceptable locations may be any area within monitoring site 102 wherein tag 200 is registered with at least one hub 300. Thus, if tag 200 is registered with at least one hub 300, it may be in an acceptable location. In other embodiments, acceptable locations may be customizable and configurable. For example, acceptable locations may depend on the particular tag 200, time of day, environmental factors, or any other factor desired. In a school setting, acceptable locations may be those classrooms in which a student associated with tag 200 should be in at a certain time.

Application 530 may generate messages having information relating to tags 200 and monitoring site 102 that may be sent to one or more computing devices. As used herein, the term “message” may include any communication format that may convey data. For example, messages may be generated or transmitted in text, data, and voice formats. Messages may indicate any status of tags 200 or hubs 300. In some embodiments, messages may be generated having location information of one or more tags 200. As used herein, the term “location information” may be any information that conveys an approximate past or present location of a tag 200. For example, location information may include what if any hubs 300 a tag 200 is registered to. In some examples, location information may include other location identifiers, such as a region, room, or elevation identifiers within monitoring site 102. In some examples, messages may be generated based on location changes of tags 200, such as when a tag 200 de-registers or exits a monitored area within monitoring site 102. In some embodiments, messages may be generated if and when a tag 200 enters or leaves an acceptable location of monitoring site 102. For example, application 530 may generate messages such as voice or SMS text messages to be sent to mobile device 510 when a tag 200 de-registers from a hub 300 in monitoring site 102.

In some embodiments, application 530 and database 540 may allow access to and store information from the tag sensors. For example, application 530 and database 540 may allow users of the system to monitor temperature, motion, or vibration of a tag 200 from data sent by sensor tags. Messages may also be generated based on sensor tag information.

In some examples, application 530 may be programmed to generate or send messages at pre-determined intervals. For example, messages may be generated and sent to external devices every half hour indicating past or present location of a tag 200. In other examples, application 530 may be configured to generate and send messages based upon certain conditions. For example, application 530 may generate and send messages when it is determined a tag 200 enters a specific area within monitoring site 102, or if it is determined tag 200 leaves an acceptable location.

FIG. 3 also provides another example of how tags 200 may move with relation to hubs 300. For example, first tag 200a may register with hub 300a via communication link 202a. Second tag 200b may move positions within monitoring site 102 to end registration with hub 300a and end communication via communication link 202a to register with hub 300b via communication link 202b. Third tag 200c may represent a tag becoming out of range or timing out from hub 300b thus terminating communication link 202c. During each of these changes, hubs 300 may communicate status signals via network 400 indicating change in location of tags 200.

The monitoring system 100 described herein with reference to the Figures may be deployed in a variety of implementations. In one embodiment, a mobile device 510 may have an application to register a tag 200 to the mobile device 510, thus becoming first registered device and a hub 300. As used herein, the term “first registered device” may include, for example, any device that may act as a hub 300 that is registered with tag 200 prior to tag 200 entering a monitoring site 102. Upon reaching the monitoring site 102, tag 200 may register with one or more hubs 300 at the monitoring site 102, and may de-register with the first registered mobile device 510. In some examples, a parent of a student or child may have a mobile device 510 that is a first registered device with tag 200 that is attachable to the student or child. When arriving at a school or day care monitoring site 102, tag 200 may register with one or more hubs 300 and may de-register with the first registered mobile device 510. This may allow hubs 300 or application 530 to monitor location of tag 200 during a drop-off transition to the monitoring site 102.

Hub 300 may communicate registration of tag 200 to application 530 via network 400, and the application 530 may correlate the unique identification information sent by tag 200 with information from database 540 (such as name, classroom, photos, etc.). In addition, hub 300 may send information gathered from a variety of tag sensors. Application 530 may cause status information from hub 300 to be stored, and application 530 may generate messages based on status changes of tag 200. For example, application 530 may generate and transmit a message to mobile device 510 regarding the registration status of tag 200.

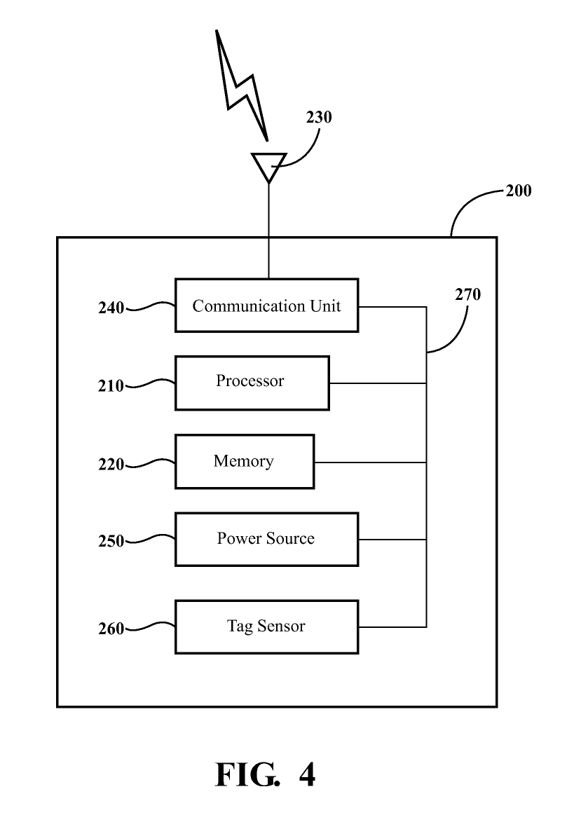

FIG. 4 is a diagram of an example of a portion of a tag 200 in which the aspects, features, and elements disclosed herein may be implemented. Tag 200 may include a processor 210, a memory 220, an electronic communication interface 230, an electronic communication unit 240, a power source 250, one or more tag sensors 260, a communication bus 270 or any combination thereof. Although shown as a single unit, any one or more element of the tag 200 may be integrated into any number of separate physical units.

In some embodiments, tag 200 may include units, or elements not shown in FIG. 4, such as a variety of tag sensors. For example, tag 200 may include elements such as an enclosure, a camera, a video camera module, a vibration device, a speaker, a microphone, a frequency modulated (FM) radio unit, a Near Field Communication (NFC) Module, a liquid crystal display (LCD) display unit, an organic light-emitting diode (OLED) display unit, or any combination thereof.

The processor 210 may include any device or combination of devices capable of manipulating or processing a signal or other information now-existing or hereafter developed, including optical processors, quantum processors, molecular processors, or a combination thereof. For example, the processor 210 may include one or more general purpose processors, one or more special purpose processors, one or more digital signal processor (DSP), one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, firmware, one or more state machines, or any combination thereof.

The processor 210 may be operatively coupled with the memory 220, the electronic communication interface 230, the electronic communication unit 240, the power source 250, or any combination thereof. For example, the processor may be operatively couple with the memory 220 via a communication bus 270.

The memory 220 may include any tangible non-transitory computer-usable or computer-readable medium, capable of, for example, containing, storing, communicating, or transporting machine readable instructions or any information associated therewith, for use by or in connection with the processor 210. The memory 220 may be, for example, one or more solid state drives, one or more memory cards, one or more removable media, one or more read only memories, one or more random access memories, one or more disks, including a hard disk, a magnetic or optical card, or any type of non-transitory media suitable for storing electronic information, or any combination thereof.

The communication interface 230 may be a wireless antenna or any other wireless unit capable of interfacing with an electronic communication medium, such as the Bluetooth wireless communication links 202a-b shown in FIG. 1. Although the Figures may show the communication interface 230 communicating via a single communication link, a communication interface may be configured to communicate via multiple communication links.

The communication unit 240 may be configured to transmit or receive signals via an electronic communication medium. The communication unit 240 may be configured to transmit, receive, or both via a wireless communication medium, such as Bluetooth radio frequency (RF). Although FIG. 3 shows a single communication unit 240 and a single communication interface 230, any number of communication units and any number of communication interfaces may be used.

The power source 250 may be any suitable device for powering the tag 200. For example, the power source 250 may include a wired power source; one or more dry cell batteries, such as nickel-cadmium (NiCd), nickel-zinc (NiZn), nickel metal hydride (NiMH), lithium-ion (Li-ion); solar cells; or any other device capable of powering the tag 200. The processor 210, the memory 220, the electronic communication interface 230, the electronic communication unit 240, or any combination thereof, may be operatively coupled with the power source 250.

One or more tag sensors 260 may be included in tag 200. Tag sensor 260 may be any suitable device for sensing characteristics of tag 200, an attached object, or the environment around tag 200. As a non-limiting example, tag sensor 260 may include temperature sensors, motion sensors, accelerometers, and vibration sensors.

Although shown as separate elements, the processor 210, the memory 220, the electronic communication interface 230, the electronic communication unit 240, or any combination thereof may be integrated in one or more electronic units, circuits, or chips.

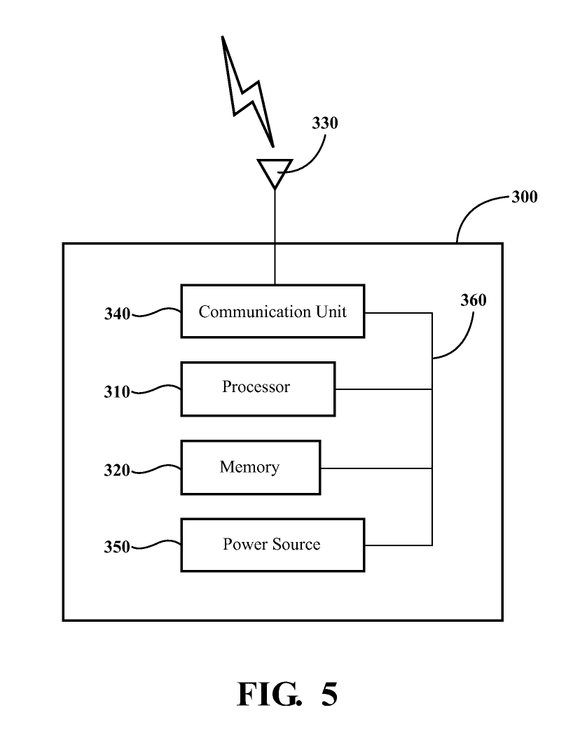

FIG. 5 is a diagram of an example of a portion of hub 300 in which the aspects, features, and elements disclosed herein may be implemented. Hub 300 may include a processor 310, a memory 320, an electronic communication interface 330, an electronic communication unit 340, a power source 350, or any combination thereof. Although shown as a single unit, any one or more element of the hub 300 may be integrated into any number of separate physical units.

In some embodiments, hub 300 may include units, or elements not shown in FIG. 5, such as environment sensors, an enclosure, a camera, a video camera module, a speaker, a microphone, a frequency modulated (FM) radio unit, a Near Field Communication (NFC) Module, a liquid crystal display (LCD) display unit, an organic light-emitting diode (OLED) display unit, or any combination thereof.

The processor 310 may include any device or combination of devices capable of manipulating or processing a signal or other information now-existing or hereafter developed, including optical processors, quantum processors, molecular processors, or a combination thereof. For example, the processor 310 may include one or more general purpose processors, one or more special purpose processors, one or more digital signal processor (DSP), one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, firmware, one or more state machines, or any combination thereof.

The processor 310 may be operatively coupled with the memory 320, the electronic communication interface 330, the electronic communication unit 340, the power source 350, or any combination thereof. For example, the processor may be operatively couple with the memory 320 via a communication bus 360.

The memory 320 may include any tangible non-transitory computer-usable or computer-readable medium, capable of, for example, containing, storing, communicating, or transporting machine readable instructions, or any information associated therewith, for use by or in connection with the processor 310. The memory 320 may be, for example, one or more solid state drives, one or more memory cards, one or more removable media, one or more read only memories, one or more random access memories, one or more disks, including a hard disk, a magnetic or optical card, or any type of non-transitory media suitable for storing electronic information, or any combination thereof.

The communication interface 330 may be a wireless antenna or any other wired or wireless unit capable of interfacing with an electronic communication medium, such as the wireless communication links 202a-b and wireless communication links 302a-b shown in FIG. 1. In some examples, communication interface 330 may include a non-omnidirectional antenna having 180 degree reception. As shown in the Figures, a communication interface may be configured to communicate via multiple communication links.

The communication unit 340 may be configured to transmit or receive signals via an electronic communication medium. The communication unit 340 may be configured to transmit, receive, or both via a wireless communication medium, such as Bluetooth radio frequency and WiFi. Although FIG. 5 shows a single communication unit 340 and a single communication interface 330, any number of communication units and any number of communication interfaces may be used.

The power source 350 may be any suitable device for powering the hub 300. For example, the power source 350 may include a wired AC power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the hub 300. The processor 310, the memory 320, the electronic communication interface 330, the electronic communication unit 340, or any combination thereof, may be operatively coupled with the power source 350.

Although shown as separate elements, the processor 310, the memory 320, the electronic communication interface 330, the electronic communication unit 340, or any combination thereof may be integrated in one or more electronic units, circuits, or chips.

Each of tag 200 and hub 300 may be controlled via operating systems that are at least partially stored on memory 220/230. For example, tags 200 and hubs 300 may be controlled by iOS, Android, Windows, Linux, or other operating systems. Such operating systems may control the allocation and usage of the components described above, and may support one more applications such as application 530.

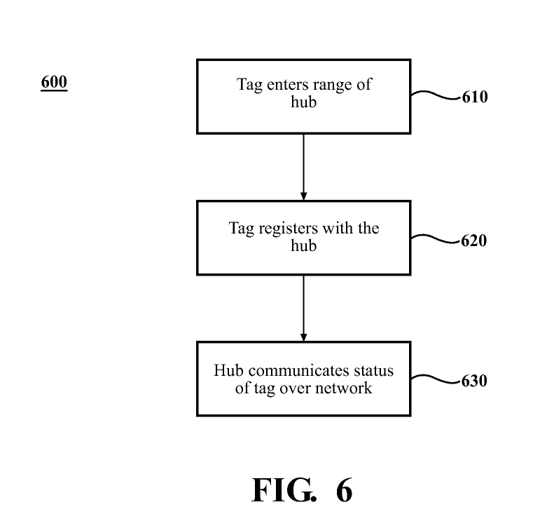

FIG. 6 is a flowchart showing an example of a process 600 of communication between a tag 200, hub 300, and network 400. The operations described in connection with the process 600 can be performed by any combination of elements of tag 200 and hub 300. For example, operations described in connection with the process 600 can be caused by execution of instructions or a software program by tag 200 or hub 300, wherein the instructions are embodied as a non-transitory computer readable storage medium including program instructions executable by one or more processors that, when executed, cause the one or more processors to perform the operations. In operation 610, tag 200 enters a range of communication with hub 300. In some embodiments, this may include tag 200 being attached to a person or object and the person or object enters into an area within a range of communication with hub 300. In operation 620, the tag 200 registers with hub 300. The registering process, further detailed with reference to FIG. 7, may include determining that tag 200 is within range with hub 300 for a period of time. In operation 630, hub 300 may communicate the status of tag 200 with network 400. For example, hub 300 may communicate that tag 200 has been registered with hub 300.

FIG. 7 is a flowchart showing an example of a process 700 for communication between tag 200 and hub 300 involving determining whether tag 200 is registered to hub 300 and whether tag 200 is out of range from hub 300. The operations described in connection with the process 700 can be performed by any combination of elements of tag 200, hub 300, and computing devices 500/510/520. For example, operations described in connection with the process 700 can be caused by execution of instructions or a software program by tag 200, hub 300, on-site computing device 500, or external computing devices 510/520 wherein the instructions are embodied as a non-transitory computer readable storage medium including program instructions executable by one or more processors that, when executed, cause the one or more processors to perform the operations.

In operation 710, tag 200 broadcasts an associated unique identification signal. For example, tag 200 may transmit a signal via Bluetooth that includes the tag's MAC address at predetermined time periods. In operation 720, hub 300 receives the identification signal if and when tag 200 is within a range of communication. In operation 730, it is determined if the hub 300 receives identification signals from tag 200 for an uninterrupted and predetermined time period. If it is not determined that hub 300 has received signals above a threshold time period, the tag is not registered to the hub. If, however, it is determined that hub 300 has received identification signals from tag 200 for the predetermined period of time, the tag 200 is registered to the hub 300 in operation 740.

In operation 750, hub 300 may communicate the status of tag 200 via network 400. For example, hub 300 may send a signal to one or more of the on-site and external computing devices 500/510/520 indicating that tag 200 has been registered with the hub 300. When tag 200 is registered with hub 300, it may be determined whether the hub 300 stops receiving identification signals from tag 200 for a predetermined time period at operation 760. If it is determined that hub 300 has stopped receiving identification signals for the time period, tag 200 may be categorized or labeled as out of range or timed out from hub 300 at operation 770. The hub 300 may communicate the status of tag 200 via the network 400 at operation 780. For example, hub 300 may send a signal to one or more of the on-site and external computing devices 500/510/520 indicating that tag 200 is now out of range with the hub 300.

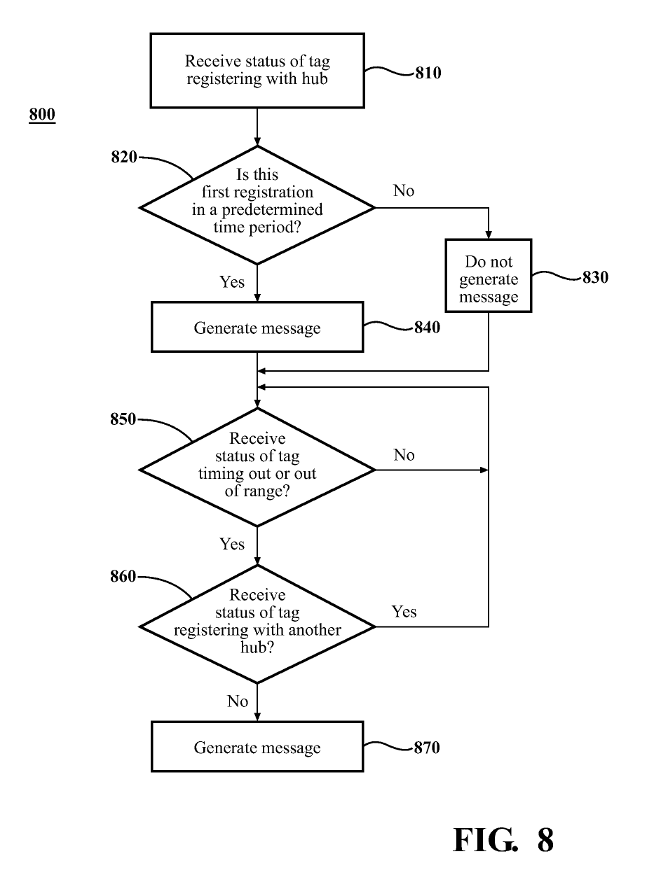

FIG. 8 is a flowchart showing an example of a process 800 of communication and message generation based on the status of one or more tags 200. The operations described in connection with the process 800 can be performed by any combination of elements of tag 200, hub 300, and computing devices 500/510/520. For example, operations described in connection with the process 800 can be caused by execution of instructions or a software program by application 530 wherein the instructions are embodied as a non-transitory computer readable storage medium including program instructions executable by one or more processors that, when executed, cause the one or more processors to perform the operations.

In operation 810, the status of a tag 200 registering with a hub 300 is received. It may then be determined if it is the first registration between tag 200 and hub 300 within a predetermined time period at operation 820. For example, it may be determined whether it is the first time tag 200 is registered with hub 300 for a particular day. If it is determined that it is not the first registration within the time period, a message is not generated at operation 830. If, however, it is determined to be the first registration between tag 200 and hub 300 within the time period, a message may be generated at operation 840. The message may simply be stored in on-site or external databases or may be shared to one or more computing devices. For example, application 530 may cause a message to be sent to on-site computing device 500 and mobile computing device 510 indicating that the person or object associated with tag 200 has arrived and registered for the first time that day. Messages to mobile computing device 510 may be in the form of an SMS text message, email address, or automated phone call.

In operation 850, the status of tag 200 being out or rage or timed out from hub 300 is received. For example, hub 300 may send such a status if the hub 300 stops receiving identification signals from tag 200. It is then determined whether or not a status is received indicating that tag 200 has registered with another hub 300 at monitoring site 102. For example, whether or not identification signals from tag 200 are received by another hub 300. If it is determined that there is no status received of tag 200 registering with another hub 300, a message may be generated indicating tag 200 is out of range with a portion of monitoring site 102 monitored by one or more hubs 300. For example, application 530 may cause a message to be sent to on-site computing device 500 and mobile computing device 510 indicating that the person or object associated with tag 200 has left an area within monitoring site 102. Messages to mobile computing device 510 may be in the form of an SMS text message, email address, or automated phone call.

Although features may be described above or claimed as acting in certain combinations, one or more features of a combination can in some cases be excised from the combination, and the combination may be directed to a sub-combination or variation of a sub-combination.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for tangibly containing, storing, communicating, or transporting electronic instructions.

The above-described aspects, examples, and implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
receiving, at a first computing device, a preemptive signal from a tag having identification information of the tag, wherein the tag is operatively connected to a moveable object;
responsive to receiving the preemptive signal, determining, by the first computing device, if the first computing device has received the preemptive signal from the tag for a predetermined period of time;
generating a tag status signal having location information of the tag within a monitoring site; and
transmitting the tag status signal over a network to a second computing device.

2. The method of claim 1, wherein the preemptive signal from the tag comprises a Bluetooth Low Energy transmission, and the first computing device is a hub positioned at a fixed location within the monitoring site.

3. The method of claim 2, wherein the tag is configured to broadcast identification information at regular intervals.

4. The method of claim 1, further comprising:
generating, at the second computing device, a message having tag location information based on the tag status signal.

5. The method of claim 4, further comprising:
transmitting the message to at least a third computing device.

6. The method of claim 5, wherein the at least a third computing device comprises a mobile computing device.

7. The method of claim 1, wherein the preemptive signal includes information from a tag sensor, and the tag status signal includes information received from the tag sensor.

8. The method of claim 7, wherein the tag sensor is one of a temperature sensor, a motion sensor, an accelerometer, and a vibration sensor.

9. The method of claim 1, wherein the network includes at least one of a local area network (LAN), a wide area network (WAN), a virtual private network (VPN), a mobile or cellular telephone network, or the Internet.

10. A method comprising:
receiving, at a first computing device, a preemptive Bluetooth signal from a tag operatively connected to a moveable object, the signal containing identification information about the tag and a first registered device;
responsive to receiving the preemptive Bluetooth signal, determining, by the first computing device, if the first computing device has received the preemptive Bluetooth signal from the tag for a predetermined period of time;
generating a tag status signal having a location of the tag within a monitoring site; and
transmitting the tag status signal over a network to a second computing device.

11. The method of claim 10, wherein the monitoring site is one of a daycare, a school, a business, and a pet care facility.

12. The method of claim 10, wherein the first registered device is a mobile computing device.

13. The method of claim 12, wherein the second computing device is the mobile computing device.

14. The method of claim 10, wherein the tag is configured for movement within a monitoring site relative to the first computing device, the first computing device positioned at a fixed location within the monitoring site.

15. The method of claim 10, further comprising:
generating, at the second computing device, a message having tag location information based on the tag status signal; and
transmitting, over the network, the message having tag location information to at least a third computing device.

16. A system for monitoring the location of one or more tags, comprising:
a tag configured to transmit, at regular intervals and without being requested, a Bluetooth wireless signal having information identifying the tag;
a plurality of hubs configured to receive the Bluetooth wireless signal when the tag is within a range of communication with the hub, the hubs include a memory and a processor configured to execute instructions stored in the memory to:
determine if the hub has received the Bluetooth wireless signal from the tag for a predetermined period of time; and
generate and transmit a tag status signal having location information of the tag; and
a first computing device communicatively linked with the hub, the first computing device includes a memory and a processor configured to execute instructions stored in the memory to:
receive the tag status signal;
determine if the tag is within an acceptable location within a monitoring site;
generate, based on the determination if the tag is within an acceptable location, a message having location information of the tag; and
transmit the message over a network to a second computing device.

17. The system of claim 16, wherein the computing device is a portion of a computing cloud.

18. The system of claim 16, further comprising a second computing device configured to receive the message transmitted over the network and display location information of the tag.

19. The system of claim 18, wherein the second computing device is a mobile computing device.

20. The system of claim 16, wherein the hub processor is further configured to:
determine if the hub stops receiving the Bluetooth wireless signal from a tag registered with the hub for a predetermined time period; and
generate and transmit a tag status signal having location information of the tag.
